(19) United States
(12) Patent Application Publication
(10) Pub. No.: US 2004/0239064 A1
(43) Pub. Date: Dec. 2, 2004

(54) Scooter bike

(76) Inventor: Clifton Deal, Mineral Bluff, GA (US)

Correspondence Address: Clifford Kraft, 320 Robin Hill Dr., Naperville, IL, 60540, US

(21) Appl. No.: 10/796,589

(22) Filed: Mar. 9, 2004

Related U.S. Application Data
(60) Provisional application No. 60/453,749, filed on Mar. 10, 2003.

(51) Int. Cl. B62M 1/00

(52) U.S. Cl. 280/87.041

(57) ABSTRACT

A scooter bike with two bicycle wheels and a bicycle frame without peddles where the rear wheel is larger than the front wheel and the scooter bike having a flat scooter floor attached to the frame between the two wheels that is generally slanted downward in the front to allow propulsion by foot power alone without peddles.

This application is related to and claims priority from U.S. provisional patent application No. 60/453,749 filed Mar. 10, 2003 and hereby incorporates that application by reference.

### BACKGROUND

1. Field of the Invention

The present invention relates generally to the field of scooters and more particularly to a scooter bike that presents a pushing effect from the front resting foot.

2. Description of the Prior Art

It is known in the art to construct bicycles and to construct scooters. Scooters have small wheels that have very little gyroscopic effect but are foot powered and fun. The small wheel diameter causes a scooter to be hard to steer and control. Bicycles have much larger gyroscopic wheels and are powered by peddles. What is needed in the art is a scooter bike that combines the larger wheels of a bicycle with the fun flat middle section of a scooter. A scooter bike would be powered by foot without peddles.

### SUMMARY OF THE INVENTION

The present invention relates to a scooter bike with both a front and rear bicycle wheel attached to a frame with handle bars and a bicycle seat, the rear bicycle wheel being larger in diameter than the front bicycle wheel. A solid scooter floor is attached to the frame between said two bicycle wheels. The scooter floor can be in proximity to the ground within about 5-6 inches. The scooter floor can be sloped with its front lower than its rear such that the scooter floor allows propulsion by foot power.

### DESCRIPTION OF THE DRAWINGS

FIG. 1 shows a side view of an embodiment of a scooter bike.

FIG. 2 shows a top view of a foot board.

### DESCRIPTION OF THE INVENTION

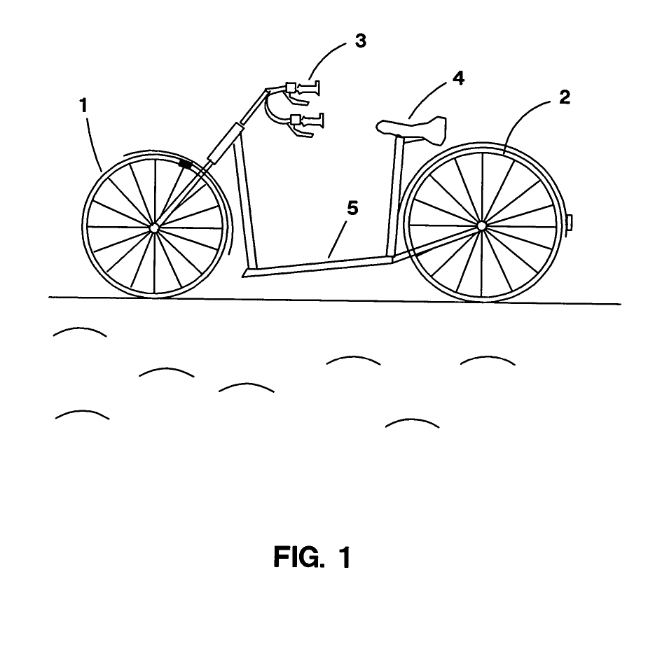

An embodiment of the present invention is shown and described in FIG. 1. A scooter bicycle combines the best features of both a scooter and a bicycle. The present invention has a frame similar to a bicycle frame except for the section between the wheels. The present invention can have handle bars 3 and a seat 4 just like a bicycle. The scooter bike of the present invention normally has the feature that the rear wheel 2 is larger than the front wheel 1 with a floor board 5 that is set several degrees with the front lower to give a push effect from the resting foot.

In the embodiment shown in FIG. 1, the front wheel 1 can be around 24 inches in diameter and the rear wheel 2 can be around 26 inches in diameter. The preferred difference in radius between the two wheels can be around 2 inches; however, many other absolute diameters and differences in diameters will work and are within the scope of the present invention.

In the embodiment shown in FIG. 1, an expanded metal floor 5 or foot brace can be around 16 inches long and 5-6 inches wide slanted front down at an incline of around 10 degrees. While 10 degrees is the preferred incline, any slant angle with the front lower than the rear is within the scope of the present invention. The effect of the slanted floor is to give a push effect from the resting foot when the device is propelled as a scooter. While the embodiments shown in FIG. 1 have no pedals, and this is the preferred embodiment, it will be evident to one skilled in the art that the device can also be provided with pedals as a normal bicycle if desired.

While many sizes and dimensions are within the scope of the present invention, it is preferred that the seat be around 16 inches rear of the handle bars and the scooter floor be around 16 inches long, and around 6 inches above the ground in the rear and around 5.5 inches above the ground in the front.

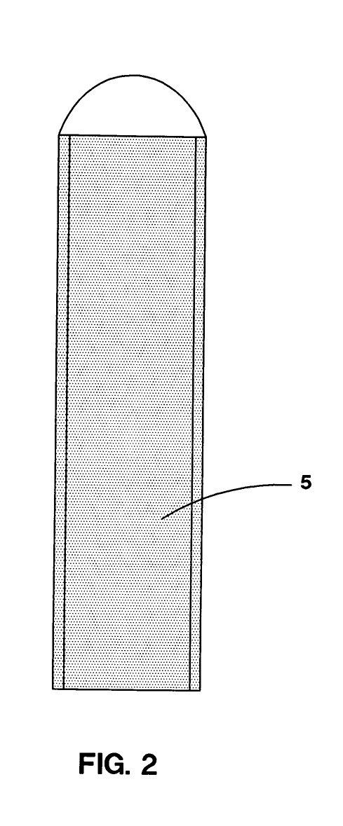

FIG. 2 shows a general top view of an embodiment of a scooter floor or foot brace. This floor is mounted near the ground between the two wheels and can be slanted downward in the front as previously described in order to yield forward motion of the scooter when the stationary foot is pushed backward.

The present invention combines the best features of both a scooter and a bicycle. In particular, the device can be propelled as a scooter yet enjoy the gyroscopic stability and maneuverability of a bicycle. While the scooter bike of the present invention can be made from any rigid material, the preferred material is aluminum for strength and lightness.

Several figures and descriptions have been presented to aid in the understanding of the present invention. One skilled in the art will note that many variations and changes are possible. These variations and changes are within the scope of the present invention.

I claim:

1. A scooter bike comprising:
a front and rear bicycle wheel attached to a frame with handle bars and a bicycle seat, the rear bicycle wheel being larger in diameter than the front bicycle wheel;
a solid scooter floor attached to said frame between said two bicycle wheels, said scooter floor being in proximity to the ground, said scooter floor being sloped with its front lower than its rear, whereby said scooter floor allows propulsion by foot power.

2. The scooter bike of claim 1 wherein said front wheel is around 2 inches smaller than said rear wheel.

3. The scooter bike of claim 1 wherein said seat is around 16 inches from said handle bars.

4. The scooter bike of claim 1 wherein said scooter floor slants downward in front by around 10 degrees.

5. The scooter bike of claim 1 wherein said scooter floor is around 6 inches above the ground at its rear and around 5.5 inches above the ground at its front.

6. The scooter bike of claim 1 wherein said front wheel is around 24 inches in diameter and said rear wheel is around 26 inches in diameter.

7. The scooter bike of claim 1 wherein said frame is aluminum.

8. A scooter bike comprising:
a front and rear bicycle wheel attached to a frame with handle bars and a bicycle seat, the rear bicycle wheel being larger in diameter than the front bicycle wheel;
a solid scooter floor attached to said frame between said two bicycle wheels, said scooter floor being in proximity to the ground, said scooter floor being sloped with its front lower than its rear, whereby said scooter floor allows propulsion by foot power;
said front wheel being around 2 inches smaller than said rear wheel and said scooter floor sloping downward around 10 degrees in front.

9. The scooter bike of claim 8 wherein said seat is around 16 inches from said handle bars.

10. The scooter bike of claim 8 wherein said scooter floor is around 6 inches above the ground at its rear and around 5.5 inches above the ground at its front.

11. The scooter bike of claim 81 wherein said front wheel is around 24 inches in diameter and said rear wheel is around 26 inches in diameter.

12. The scooter bike of claim 8 wherein said frame is aluminum.
